(19) United States
(12) Patent Application Publication
(10) Pub. No.: US 2014/0070076 A1
(43) Pub. Date: Mar. 13, 2014

(54) Real-Time Composite 3-D for a Large Field of View Using Multiple Structured Light Sensors

(71) Applicants: GOUTHAM MALLAPRAGDA, BRENTWOOD, TN (US); ASHWIN MUDIGONDA, NASHVILLE, TN (US)

(72) Inventors: GOUTHAM MALLAPRAGDA, BRENTWOOD, TN (US); ASHWIN MUDIGONDA, NASHVILLE, TN (US)

(21) Appl. No.: 14/025,709

(22) Filed: Sep. 12, 2013

Related U.S. Application Data
(60) Provisional application No. 61/700,025, filed on Sep. 12, 2012.

(51) Int. Cl. G01J 1/02

(52) U.S. Cl. CPC G01J 1/0271
USPC 250/208.1

(57) ABSTRACT

An apparatus for mounting and connecting a plurality of structured light sensors to a personal computer or other computing device. Up to eight structured light sensors of different size and configurations are adjustably mounted to allow positioning of each sensor as desired. The positioning permits the resolution of the sensors to be optimized without compromising the field of view. Where each structure projects a structured light pattern, several mechanisms are sued to control sequential interference-free collection of data. Mechanisms include mechanical shutters, electrically controllable polarized glass, and software control of a sensor's projector.

This application claims benefit of and priority to U.S. Provisional Application No. 61/700,025, filed Sep. 12, 2012, by Goutham Mallapragda, et al., and is entitled to that filing date for priority. The specification, figures and complete disclosure of U.S. Provisional Application No. 61/700,025 are incorporated herein by specific reference for all purposes.

### FIELD OF INVENTION

This invention relates to an apparatus with mounts for multiple structured light sensors (or depth cameras). More specifically, this invention relates to an apparatus with mounts for multiple structured light sensors located so as to optimize resolution without compromising the field of view.

### SUMMARY OF INVENTION

In various embodiments, the present invention comprises an apparatus for mounting and connecting a plurality of structured light sensors to a personal computer or other computing device (e.g., tablet computer, game console, or the like). In one exemplary embodiment, up to eight structured light sensors, such as a Microsoft Kinect, are mounted. Conduits may be provided to route cables and wires between the sensors and the computing device (which also may be mounted on the apparatus). Mounts are adjustable to accommodate different sizes and configurations of sensors, and to allow positioning of each sensor as desired. The positioning permits the resolution of the sensors to be optimized without compromising the field of view.

In one embodiment, where each sensor projects an infrared grid as the structured light pattern, using more than one sensor can severely hamper the accuracy of the point cloud. A mechanical shutter system apparatus opens and closes a shutter in front of the projection for a specific sensor at a given time. Using software triggering, a control system synchronizes the multiple light sensor signals. When data needs to be gathered from a particular sensor, the shutter associated with it is opened briefly to allow for interference-free collection of data. The real-time shuttering of the signals allows the system to remove interference between the multiple sensors.

In another embodiment, electrically controllable polarized glass may be used instead of mechanical shutters to provide the shuttering of the signals. Alternatively, each sensor's projector may be turned on or off by software so that that sensor may not project structured light onto the scene.

In yet another embodiment, the system captures the 3-D point clouds at the same time from two or more structured light sensors. Calibration (which may be one time) may be required to determine the relative position of the sensors. In one exemplary embodiment of the calibration protocol, a checkerboard pattern is presented to the Kinect sensor pair. When both the Kinect sensor pairs identify the squares from the image data, their 3-D position is extracted from the depth data, and this can be used to compute the relative position of one with respect to the other.

Once calibration is performed, all the point clouds can be registered to a common origin. The system then accurately reconstructs the multiple 3-D point clouds of objects in real-time into one composite 3-D point cloud. Noise and overlap within or between multiple point clouds are removed using heuristic algorithms.

In yet another embodiment, the system can reconstruct 3-D point clouds captured from different sensors at different times. Two point clouds captured in this manner are aligned using an algorithm such that the time-spaced clouds are merged and transformed to a common origin.

In yet a further embodiment, the present invention comprises a method for extending the length of USB connectivity for a sensor. In one embodiment, a sensor can be made operational over distances of up to 100 meters in an industrial environment.

### DESCRIPTION OF THE DRAWINGS

FIGS. 1-3 show views of a structured light sensor mount in different configurations in accordance with an exemplary embodiment of the present invention.

FIG. 4 shows a front view of a structured light sensor mount.

FIG. 5 shows a side cut-away view of a structured light sensor mount.

FIGS. 6-11 shows views of alternative forms of a structured light sensor mount. in accordance with another exemplary embodiment of the present invention.

FIG. 12 shows a calibration plate to automatically calibrate multiple sensors with respect to each other.

FIG. 13 shows a view of an example of a fully-stitched depth map.

FIG. 14 shows a view of an example of segmented boards.

FIGS. 15-18 show views of apparatus with eight structured light sensor mounts in accordance with another exemplary embodiment of the present invention.

### DETAILED DESCRIPTION OF EXEMPLARY EMBODIMENTS

Structured light processing is the process of projecting a known pattern of pixels or light image (often grids or horizontal bars) onto a scene or object of interest. The pattern deforms when striking surfaces, and the observing the manner in which the known pattern deforms allows vision systems to calculate depth and surface information regarding the object or objects in the scene.

In order to obtain maximum resolution without loss of signal quality, a structured light sensor, such as, but not limited to, the Microsoft Kinect, has to be placed at a certain minimum height from the object being sensed or scanned. While this arrangement typically addresses the issue of resolution, it does result in a loss of field of view of the scene. The Microsoft Kinect, and uses thereof, are disclosed in Latta, et al., “Gesture Keyboarding,” U.S. application Ser. No. 12/391,145; Newcomb, et al., “Real-Time Camera Tracking Using Depth Maps,” U.S. application Ser. No. 13/017,587; and Fuller, et al., “Living Room Movie Creation,” U.S. application Ser. No. 13/017,750; all of which are incorporated herein by specific reference in their entireties for all purposes.

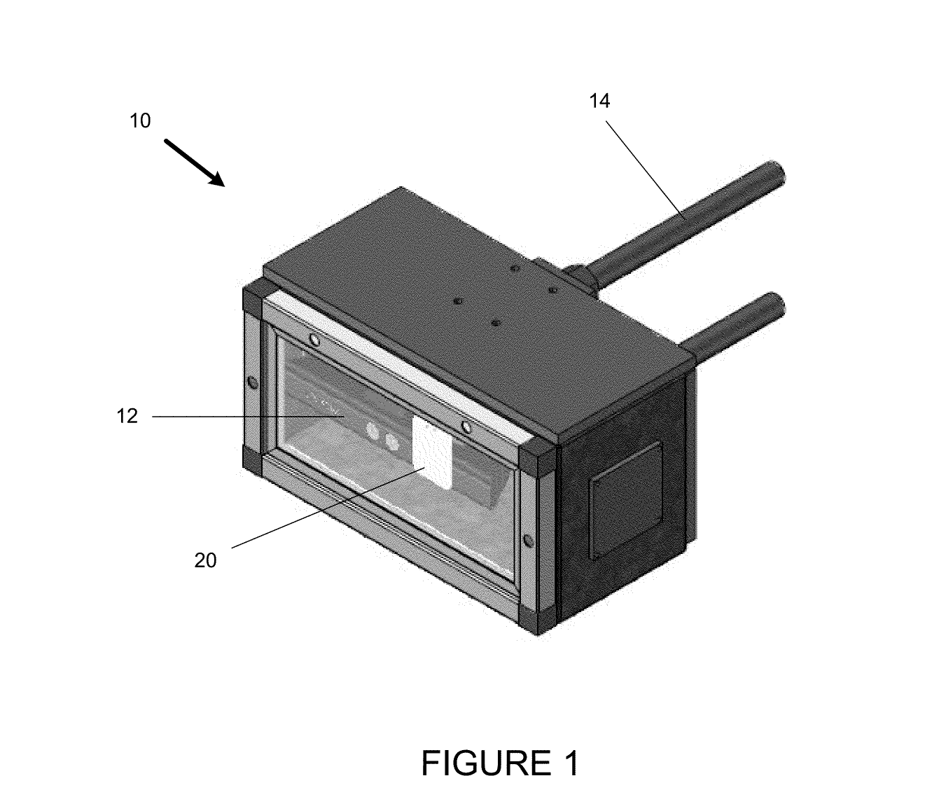

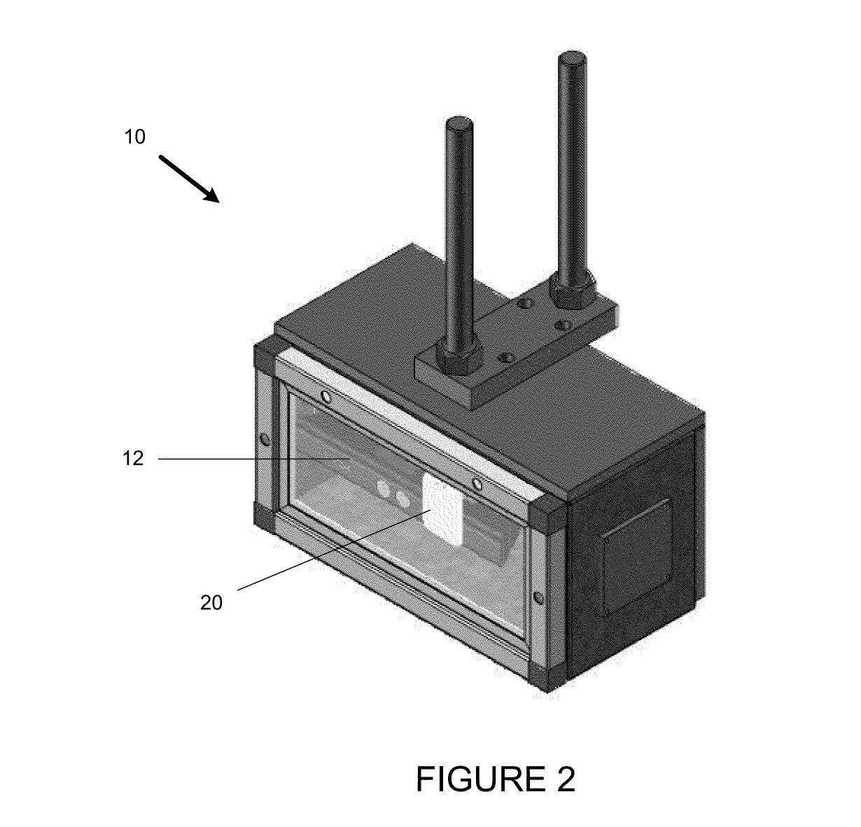

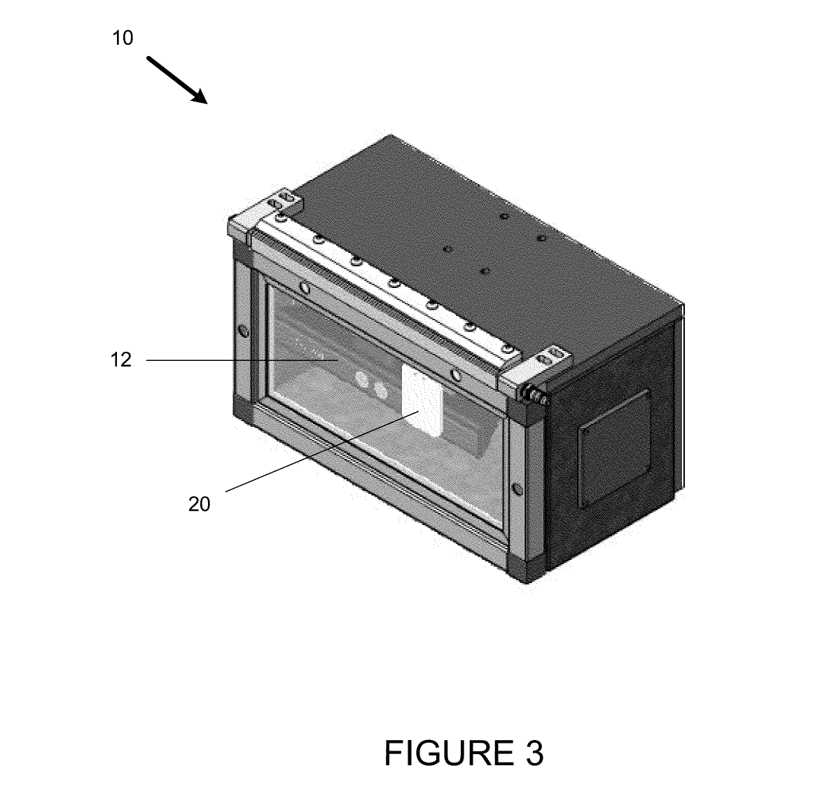

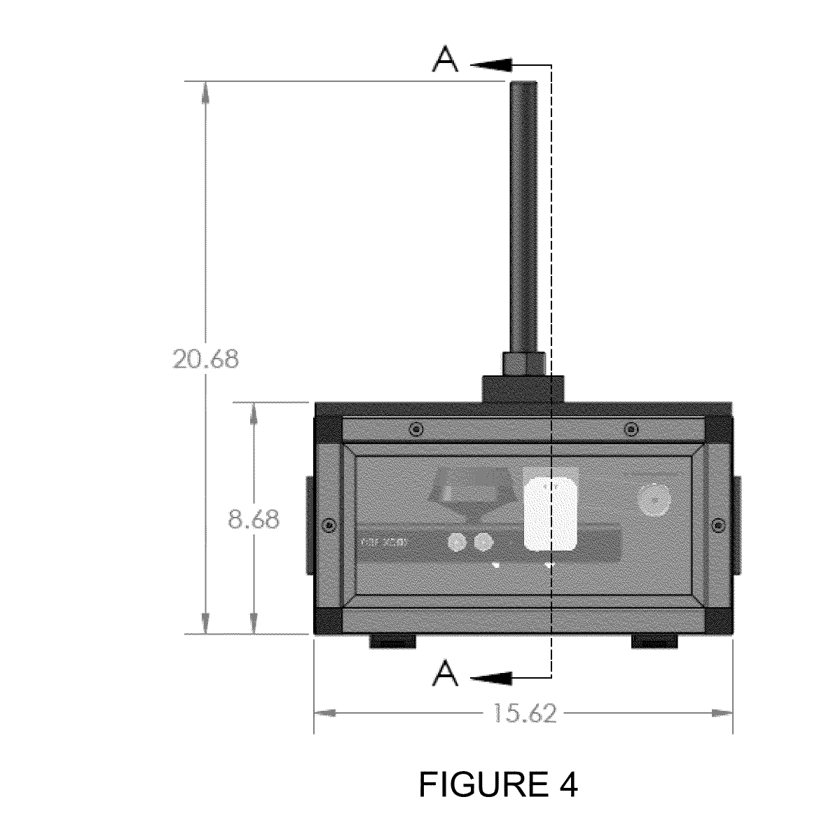

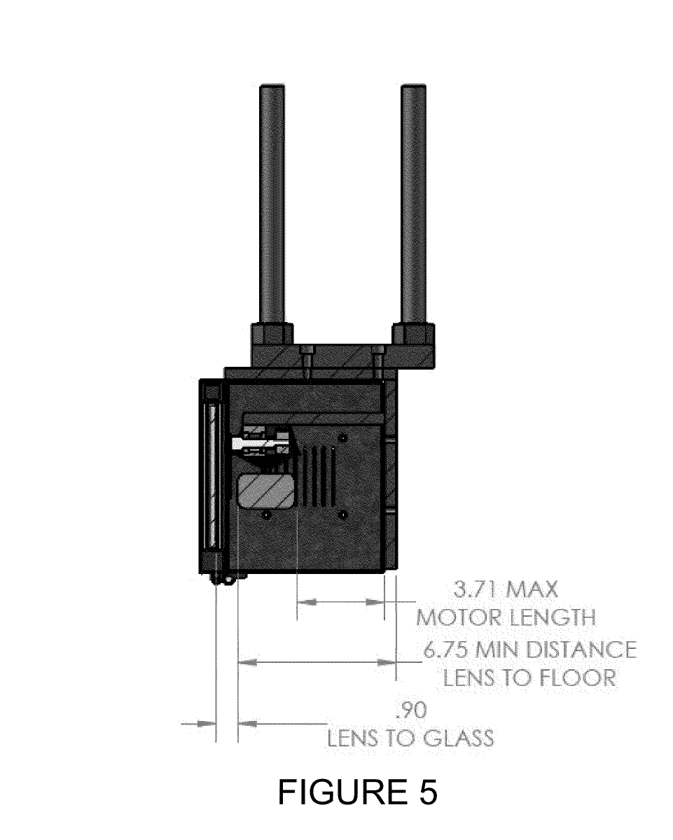

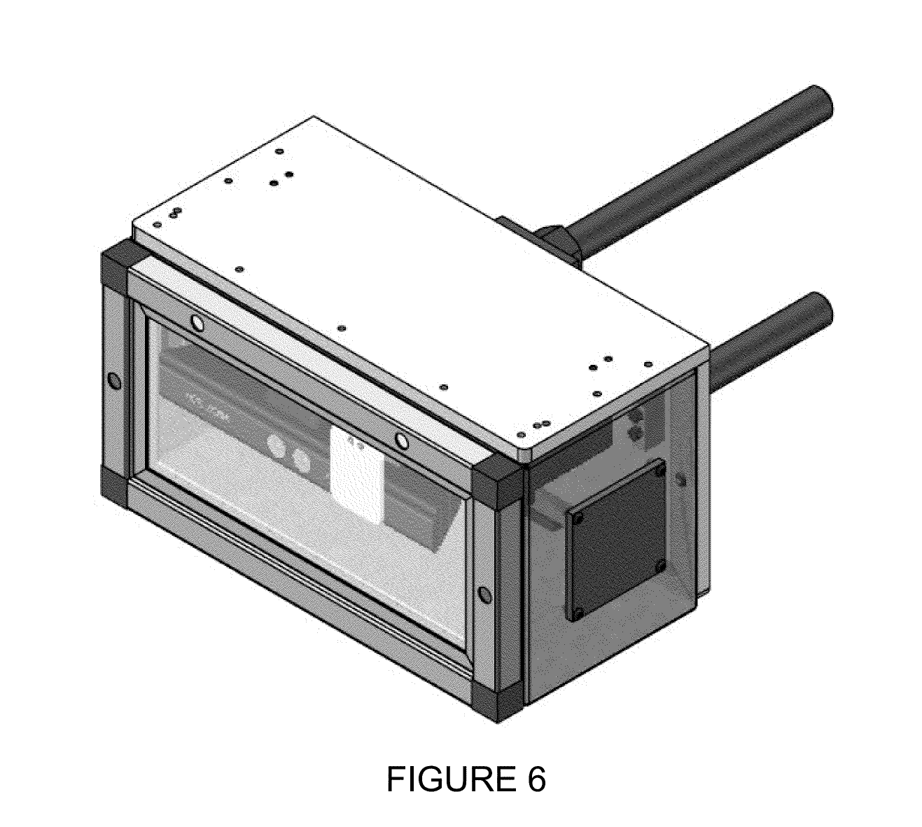

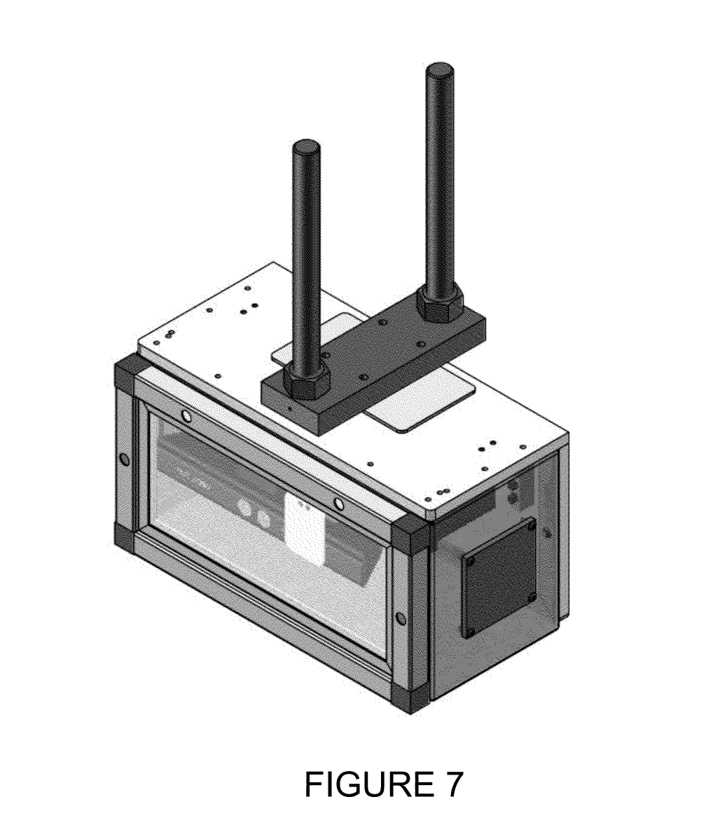

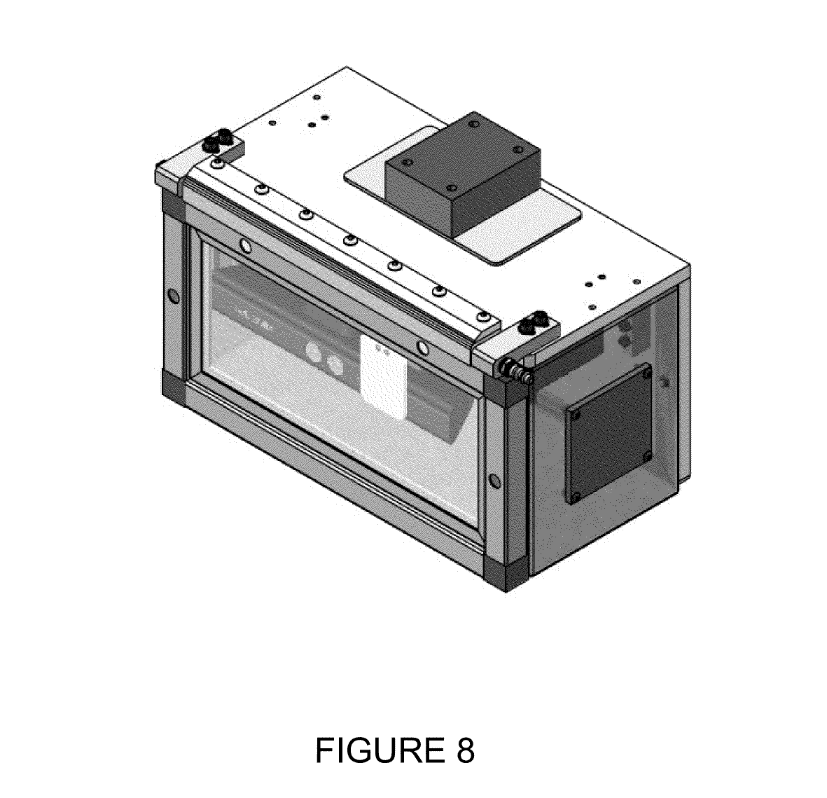

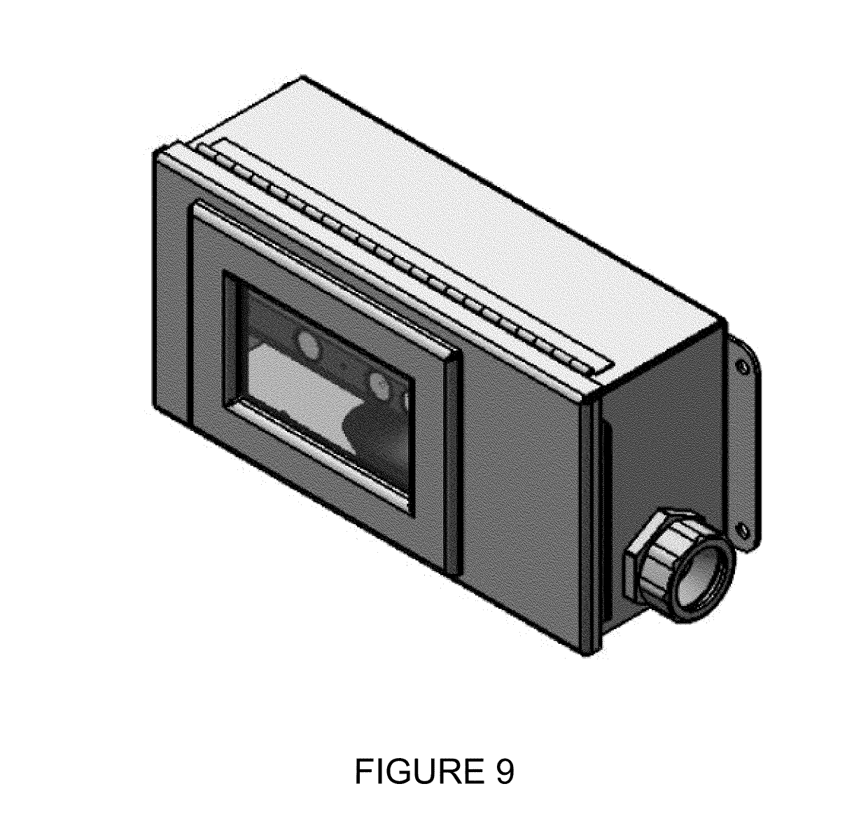

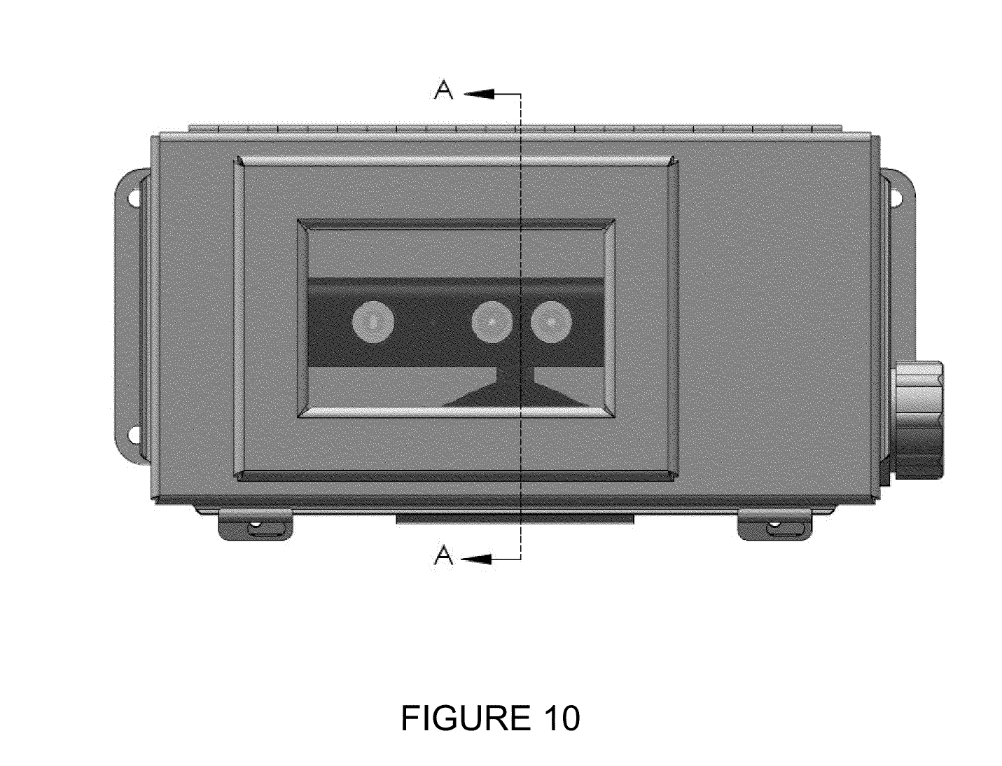

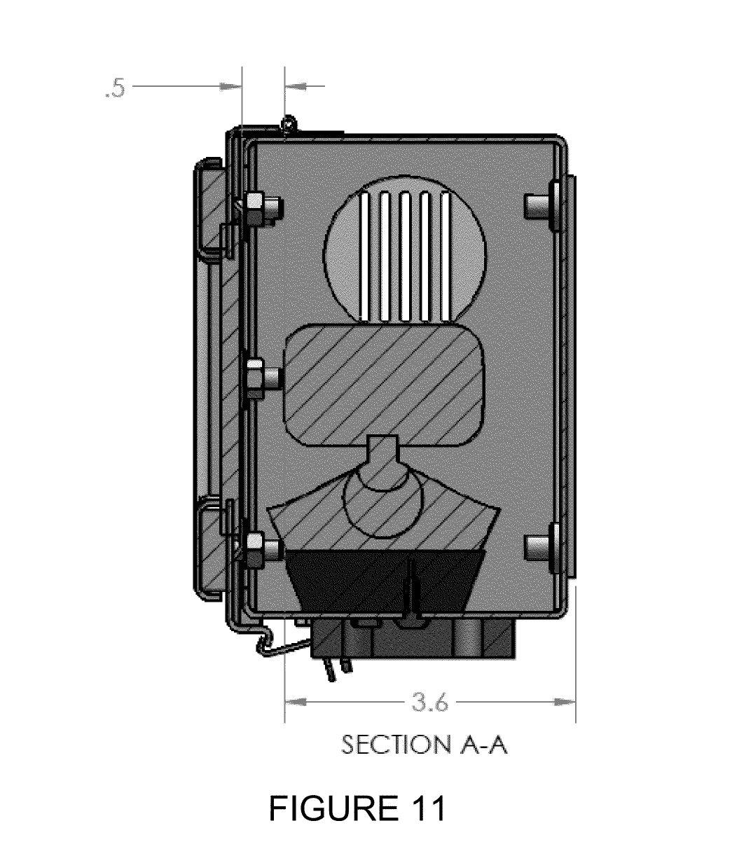

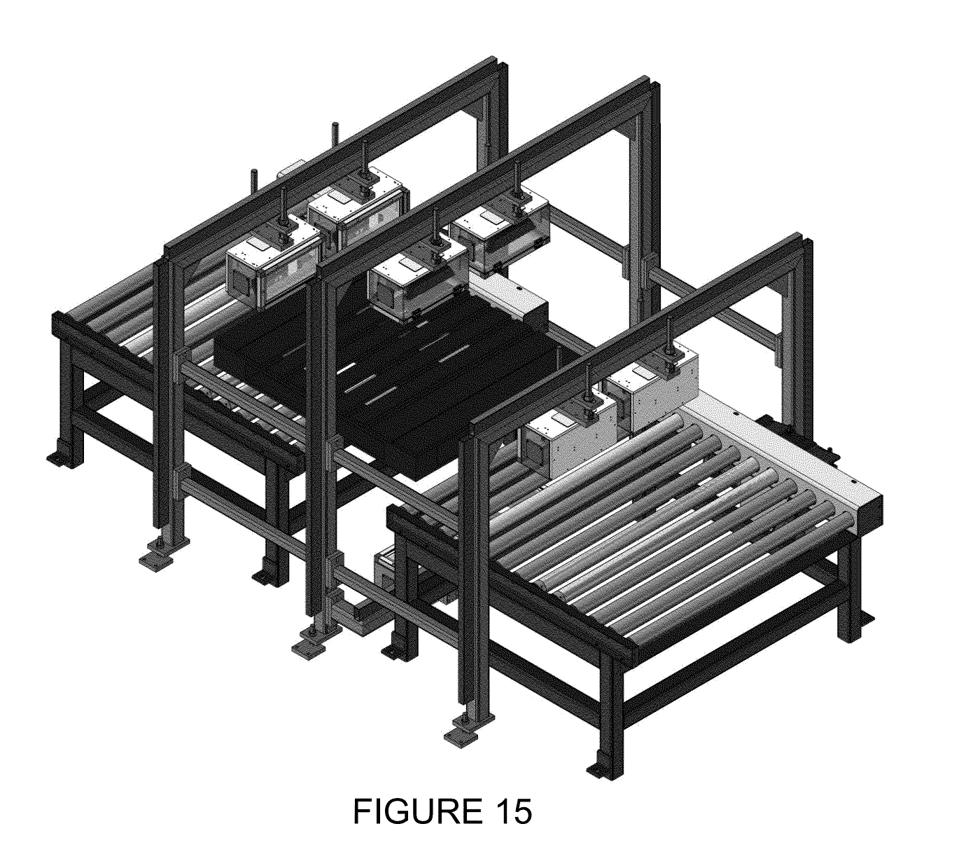

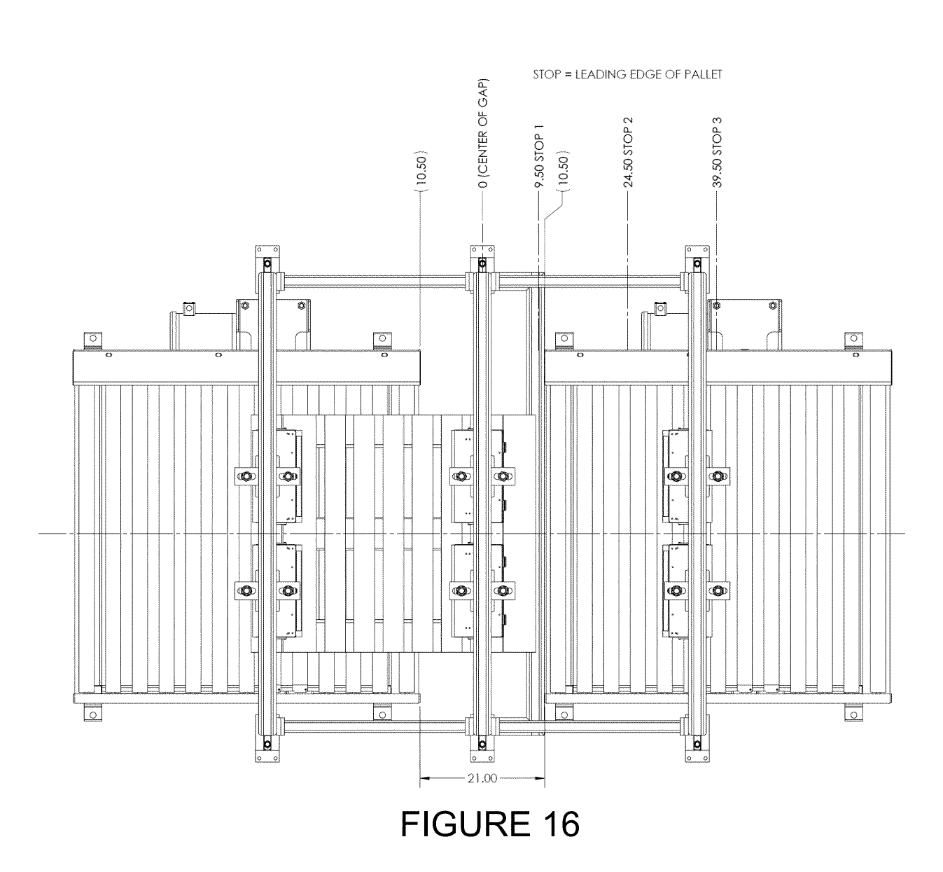

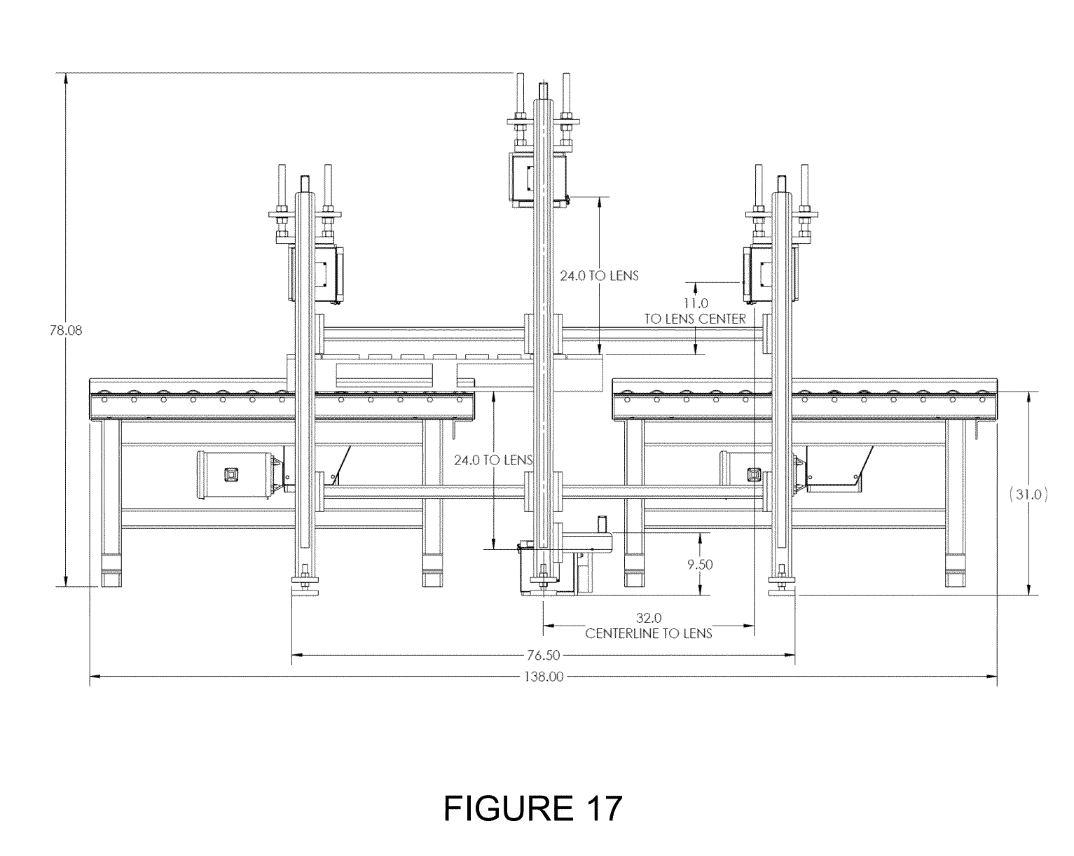

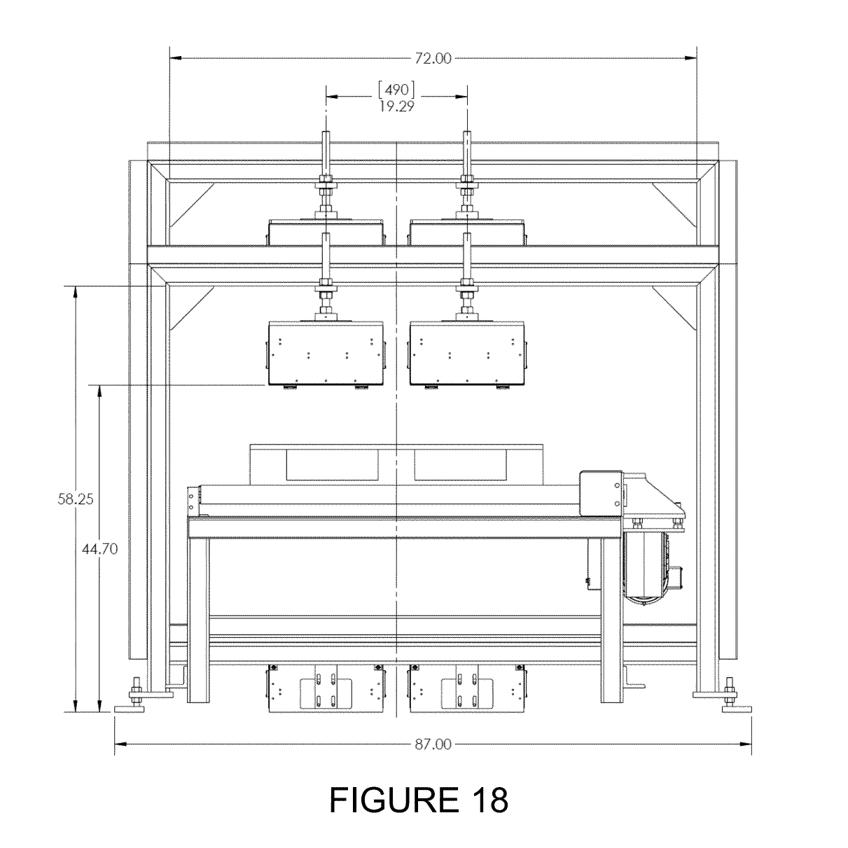

In various exemplary embodiments, as seen in FIGS. 1-11, the prevent invention comprises an apparatus 10 for mounting and connecting a plurality of structured light sensors 12 to a personal computer or other computing device (e.g., tablet computer, game console, or the like). In one exemplary embodiment, as seen in FIGS. 15-18, up to eight structured light sensors 12, such as the Kinect, are mounted. Conduits 14 may be provided to route cables and wires between the sensors and the computing device (which also may be mounted on the apparatus). Mounts are adjustable to accommodate different sizes and configurations of sensors, and to allow positioning of each sensor as desired. The positioning permits the resolution of the sensors to be optimized without compromising the field of view.

In one embodiment, where each sensor (such as a Kinect) projects an infrared grid as the structured light pattern, using more than one sensor can severely hamper the accuracy of the point cloud. A mechanical shutter system apparatus 20 opens and closes a shutter in front of the projection or sensor for a specific sensor at a given time. Using software triggering, a control system synchronizes the multiple light sensor signals. When data needs to be gathered from a particular sensor, the shutter associated with it is opened briefly to allow for interference-free collection of data. The real-time shuttering of the signals allows the system to remove interference between the multiple sensors.

In another embodiment, electrically controllable polarized glass may be used instead of mechanical shutters to provide the shuttering of the signals. Alternatively, each sensor's projector may be turned on or off by software so that that sensor may not project structured light onto the scene.

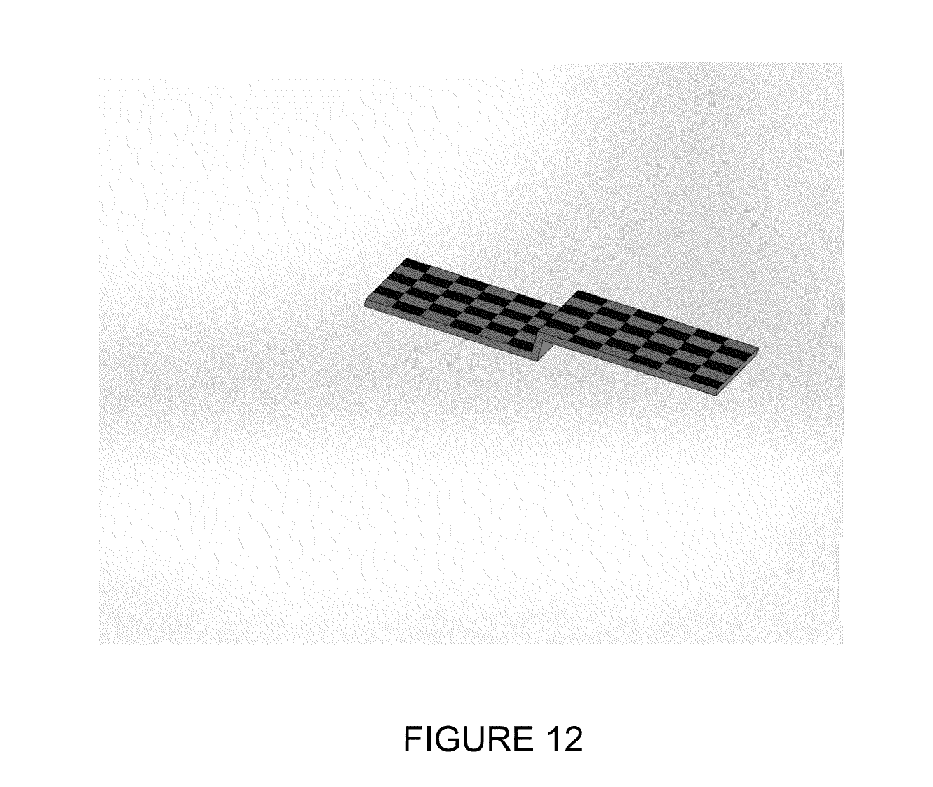

In yet another embodiment, the system captures the 3-D point clouds at the same time from two or more structured light sensors. Calibration (which may be one time) may be required to determine the relative position of the sensors. In one exemplary embodiment of the calibration protocol, a checkerboard pattern, as seen in FIG. 12, is presented to the Kinect sensor pair. When both the Kinect sensor pairs identify the squares from the image data, their 3-D position is extracted from the depth data, and this can be used to compute the relative position of one with respect to the other.

Once calibration is performed, all the point clouds can be registered to a common origin. The system then accurately reconstructs the multiple 3-D point clouds of objects in real-time into one composite 3-D point cloud. Noise and overlap within or between multiple point clouds are removed using heuristic algorithms.

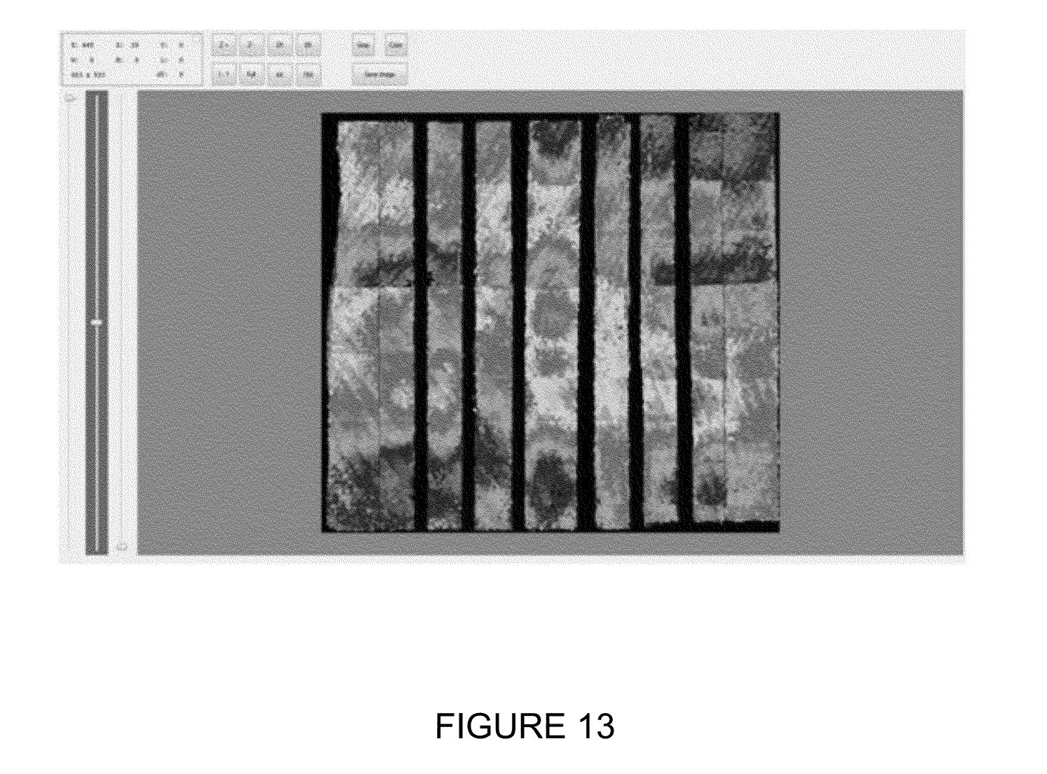

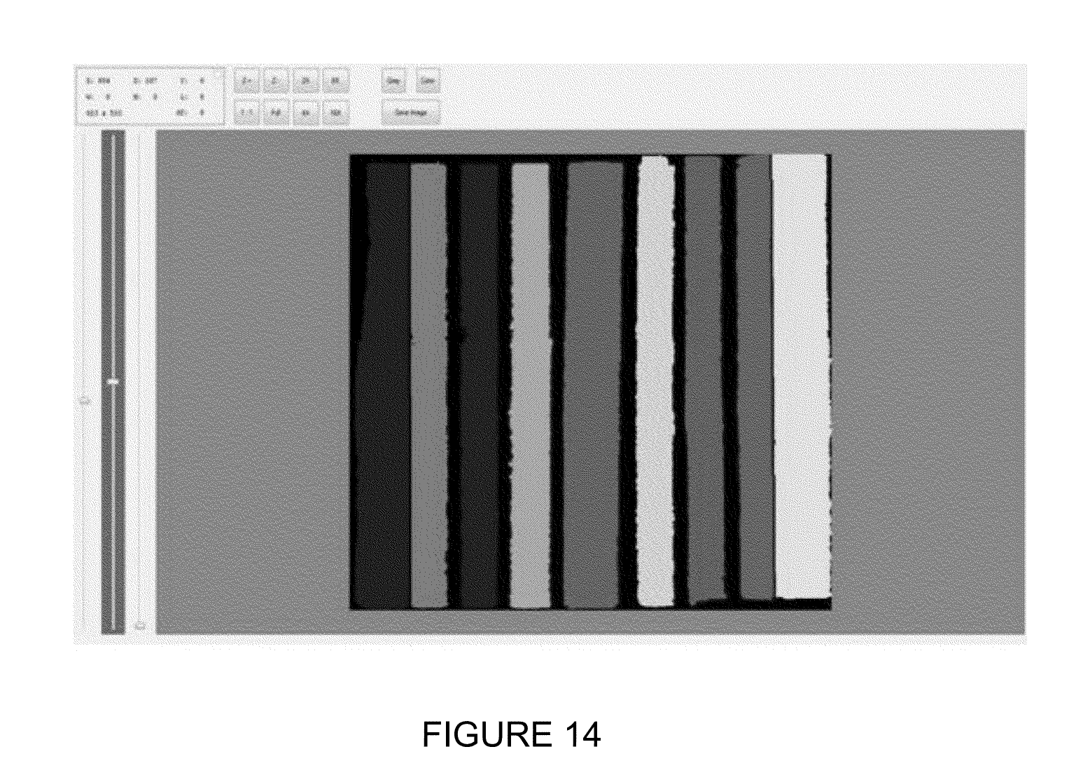

In yet another embodiment, the system can reconstruct 3-D point clouds captured from different sensors at different times, as seen in FIGS. 13 and 14. Two point clouds captured in this manner are aligned using an algorithm such that the time-spaced clouds are merged and transformed to a common origin.

In yet a further embodiment, the present invention comprises a method for extending the length of USB connectivity for a sensor. In one embodiment, a sensor can be made operational over distances of up to 100 meters in an industrial environment. The embodiments described above can be used with single objects, stationary or moving objects, multiple objects, and an object or objects over time. The structured light source can be visible spectrum or invisible spectrum (e.g., infrared).

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for large field of view structured light processing, comprising:
a plurality of light mounts;
a plurality of structured light sensors mounted on said plurality of light mounts; and
at least one computing device in electronic communication with said plurality of structured light sensors;
wherein said light mounts are adjustable to move said structured light sensors to a variety of different positions; and
wherein two or more of said structured light sensors comprise a structured light pattern projector adapted to project a structured light pattern, and means for preventing simultaneous projection of said structured light patterns by said structured light pattern projectors.

2. The apparatus of claim 1, wherein said preventing means comprises a mechanical shutter.

3. The apparatus of claim 1, wherein said preventing means comprises electrically controllable polarized glass.

4. The apparatus of claim 1, wherein said means comprises a computer processor or microprocessor programmed to turn said structured light projectors on and off.
